(19) United States
(12) Patent Application Publication
(10) Pub. No.: US 2021/0291571 A1
(43) Pub. Date: Sep. 23, 2021

(54) PRESSURE ADJUSTING STRUCTURE FOR PRINTING HEAD

(71) Applicant: CHIEN HWA COATING TECHNOLOGY, INC., Hsinchu City (TW)

(72) Inventors: YULUNG TSAO, HSINCHU CITY (TW); YIWEI LIN, HSINCHU CITY (TW); CHUNCHEN CHEN, HSINCHU CITY (TW)

(21) Appl. No.: 16/884,412

(22) Filed: May 27, 2020

(30) Foreign Application Priority Data
Mar. 19, 2020 (TW) 109109213

(51) Int. Cl. B41J 25/312; B41J 2/335

(52) U.S. Cl. CPC B41J 25/312; B41J 2/33505

(57) ABSTRACT

The present invention provides a pressure adjusting structure for printing head. A first pressure plate is disposed on a circuit board. Two elastic members are disposed on the first pressure plate. One end of the two elastic members provides downward force, respectively; the other end thereof is against a second pressure plate, respectively. An adjusting member passes through the second pressure plate. One end of the adjusting member is projective to the second pressure plate such that a user can adjust the downward pressure of the first pressure plate. By ensuring the pressure value within the optimum pressure range, the superior printing quality can be achieved.

### FIELD OF THE INVENTION

The present invention relates generally to a pressure adjusting structure for printing head, and particularly to a structure for adjusting the downward pressure of the pressure plate by using an elastic member and an adjusting member.

### BACKGROUND OF THE INVENTION

As technologies and commerce develop, invoices re receipts are required while paying a bill. Hence, a printer is included in a cashier. In particular, a heat sensitive printer (or a thermal printer) is a popular product widely adopted in retail, catering, and transportation businesses for printing receipts, price tags, or transportation details. As the applications of printers are extended, the types of printing media adopted by users vary. Since the structures of thermal printers can be made small, they are extensively adopted. Thermal printers uses thermal paper (or called heat sensitive paper).

The thermal paper adopts a chemical material coated thereon so that the color of the paper can be changed after being heated. No ink is required in the process. The thermal paper can be used in a thermal printer disposed in a lightweight and small-sized device such as a fax machine, an addometer, a cashier, and a credit-card terminal for reducing the cost.

The surface of the thermal paper will be coated with solid dye and appropriate base material, such as fluorane-type invisible dye and octadecylphosphonic acid. When the base material is heated to the melting point, the dye will react with the acid material and turn to the colored state. The base material can be cooled down easily, and the colored state of the dye will be stored in a sub-stable state. After a period, the color still will fade. Thereby, the thermal paper is only suitable for applications not requiring long-term storage.

Normally, the dye will turn to black after being heated. But sometimes, dyes turning to blue or red will be adopted instead. An open heat source, such flames, will change the color of the paper. Rubbing the paper rapidly will provide sufficient thermal energy to generate a colored mark. Right before the thermal paper roll is running up, a red stripe will appear on the edge for reminding the user of replacing the paper roll.

The pressure of the printing head of the thermal printer according to the prior art and the thickness and width of the printing media are related to the printing temperature. Different types of printing media require different pressure of the printing head module. According to the prior art, the downward pressure of the printing head is not adjustable. Since the pressure of the printing head module imposes apparent influence on the printing quality, the industry needs a structure capable of adjusting the pressure of the printing head on the printing media.

Accordingly, the present invention provides a pressure adjusting structure for printing head. A first pressure plate is disposed on a circuit board. Two elastic members are disposed on the first pressure plate. One end of the two elastic members provides downward force, respectively; the other end thereof is against a second pressure plate, respectively. An adjusting member passes through the second pressure plate for adjusting the downward pressure of the first pressure plate. By ensuring the pressure value within the optimum pressure range, the superior printing quality can be achieved.

### SUMMARY

An objective of the present invention is to provide a pressure adjusting structure for printing head. A first pressure plate is disposed on a circuit board. Two elastic members are disposed on the first pressure plate. The other end of the two elastic members is against a second pressure plate, respectively. The second pressure plate and the two elastic members provide downward force. The movement of the second pressure plate can be adjusting by an adjusting member for adjusting the downward pressure of the first pressure plate. Thereby, the printing quality of the printing head can be improved.

The present invention provides a pressure adjusting structure for printing head. A first pressure plate is disposed on a circuit board. A end of the two elastic members are disposed a top of the first pressure plate. A end of the two elastic members provides downward force, respectively; the other end thereof is against a second pressure plate, respectively. An adjusting member passes through the second pressure plate. A end of the adjusting member is projective to a top of the second pressure plate such that the downward pressure of the first pressure plate can be adjusted for adapting to various printing materials.

According to an embodiment of the present invention, the other end of the adjusting member includes a holding member.

According to an embodiment of the present invention, the adjusting member includes an outer thread.

According to an embodiment of the present invention, the circuit board is a thermal printing chip.

According to an embodiment of the present invention, the circuit board is against a wheel member.

According to an embodiment of the present invention, the circuit board is connected below the first pressure plate.

According to an embodiment of the present invention, a support member is disposed on the second pressure plate and the adjusting member is projective to the support member.

According to an embodiment of the present invention, the adjusting member is located between the two elastic members.

### BRIEF DESCRIPTION OF THE DRAWINGS

FIG. 1 shows a structural schematic diagram according to an embodiment of the present invention;

FIG. 2 shows an operational schematic diagram according to an embodiment of the present invention; and

FIG. 3 shows another structural schematic diagram according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a pressure adjusting structure for printing head. A first pressure plate is disposed on a circuit board. Two elastic members are disposed on the first pressure plate. The other end of the two elastic members is against a second pressure plate, respectively. The movement of the second pressure plate and the two elastic members provide the downward forces on the first pressure plate. Then an adjusting member passes through the second pressure plate. One end of the adjusting member is against the first pressure plate. The other end thereof is projective to the second pressure plate. The adjusting member can adjust the movement of the second pressure plate for adjusting the downward pressure on the first plate. By ensuring the pressure value within the optimum pressure range, the superior printing quality can be achieved.

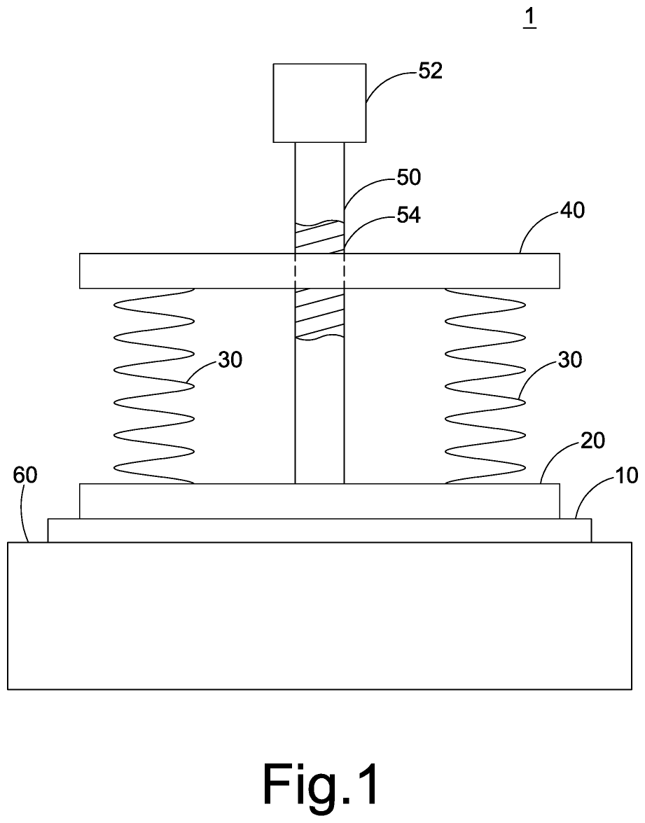

Please refer to FIG. 1, which shows a structural schematic diagram according to an embodiment of the present invention. As shown in the figure, the present invention provides a pressure adjusting structure for printing head 1, which comprises a circuit board 10, a first pressure plate 20, two elastic members 30, a second pressure plate 40, and an adjusting member 50 passing through.

Please refer again to FIG. 1. As shown in the figure, according to the present embodiment, the circuit board 10 is a thermal printing chip, for example, the thermal printing head according to the prior art. The first pressure plate 20 is disposed on the circuit board 10. One end of the two elastic member 30 is disposed on the first pressure plate 20, respectively. In other words, the two elastic members 30 are connected to the first pressure plate 20, respectively. The second pressure plate 40 is against the other ends of the two elastic members 30. The adjusting member 50 passes through the second pressure plate 40 to the first pressure plate 20. Besides, one end of the adjusting member 50 is projective to the second pressure plate 40 such that a user can rotate the adjusting member 50. According to the present embodiment, the circuit board 10 is connected below the first pressure plate 20. The connection method can be the connection methods according to the prior art such as locking and gluing. The adjusting member 50 is located between the two elastic members 30 for balancing the structural distribution of the two elastic members 30 and avoiding uneven distribution of pressure provided by the two elastic members 30.

According to the present embodiment, a holding member 52 is disposed on the other end of the adjusting member 50. The adjusting member 50 can be put around the adjusting member 50 as the connection. The holding member 52 is a holding device for users to rotate the adjusting member 50 conveniently.

According to the present embodiment, the adjusting member 50 include an outer thread 54 so that the adjusting member 50 can be screwed to the second pressure plate 40. Thereby, the second pressure plate 40 includes an inner thread corresponding to the outer thread 54 of the adjusting member 50 to connect the two threads by screw connection.

According to the present embodiment, the circuit board 10 is against a wheel member 60, which is the wheel driving printing paper according to the prior art.

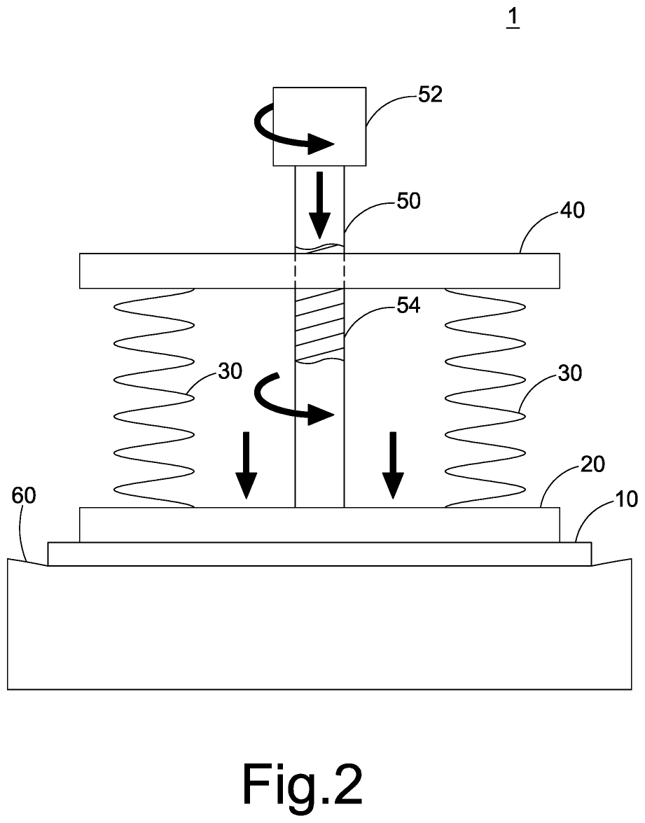

Please refer to FIG. 2, which shows an operational schematic diagram according to an embodiment of the present invention. As shown in the figure, according to the present embodiment, the adjusting member 50 is rotated in a direction to move downwards. Meanwhile, the second pressure plate 40 pushes the two elastic members 30 downwards. Owing to the elasticity of the material, the two elastic members 30 extend outwards to press the first pressure plate 20 and provide the first pressure plate 20 with a larger pressure. Thereby, by rotating the adjusting member 50, the downward pressure of the first pressure plate 20 can be increased. As the adjusting member 50 is rotated in the other direction, the second pressure plate 40 is moved upwards. Due to the elasticity of the material of the two elastic member 30 disposed on the first pressure plate 20, the force exerted on the first pressure plate 20 is reduced and thus providing a smaller pressure. Thereby, by rotating the adjusting member 50, the downward pressure of the first pressure plate 20 can be reduced.

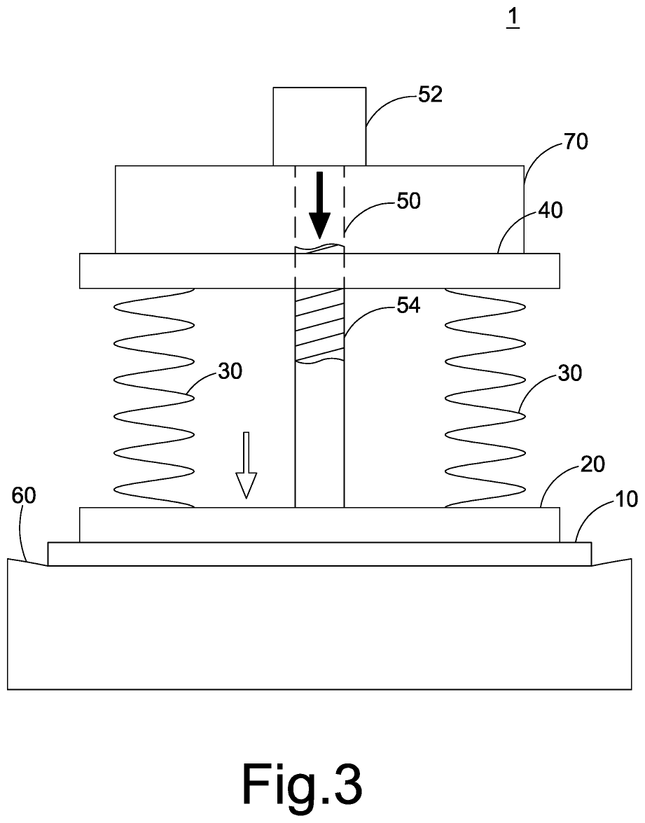

Please refer to FIG. 3, which shows another structural schematic diagram according to an embodiment of the present invention. As shown in the figure, a support member 70 is disposed on the second pressure plate 40 of the above structure. The adjusting member 50 passes through the support member 70 and is projective to the support member 70. The support member 70 fixes the location of the adjusting member 50 and allows the adjusting member 50 to rotate about the support member 70 and hence driving the second pressure plate 40 to move downwards. The support member 70 is connected to the other structures of the printer, such as the case of the printer, for supporting the pressure adjusting structure for printing head 1. The connection and operation of the other components according to the present embodiment are identical to those according to the above embodiment. Hence, the details will not be described again.

According to the present embodiment, the first pressure plate 20 is disposed on the circuit board 10. Two elastic members 30 are disposed on the first pressure plate 20. The other end of the two elastic members 30 is against the second pressure plate 40, respectively. The movement of the second pressure plate 40 and the two elastic members 30 provide the downward force on the first pressure plate 20. The adjusting member 50 passes through the second pressure plate 40. One end of the pressure plate 50 is against the first pressure plate 20. The other end of the pressure plate 50 is projective to the second pressure plate 40. The adjusting member 50 adjusts the movement of the second pressure plate 40.

To sum up, the present invention provides a pressure adjusting structure for printing head. A first pressure plate is disposed on a circuit board. Two elastic members are disposed on the first pressure plate. The other end of the two elastic members is against the second pressure plate, respectively. The adjusting member adjusts the second pressure plate and compresses the two elastic members to provide the downward force on the first pressure plate. The present invention uses the adjusting member to move the second pressure plate and adjust the two elastic members and the downward pressure on the first pressure plate. By ensuring the pressure value within the optimum pressure range for adapting to various printing media, the superior printing quality can be achieved.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A pressure adjusting structure for printing head, comprising:
a circuit board;
a first pressure plate disposed on said circuit board;
two elastic members, a end of side two elastic members disposed a top of said first pressure plate, respectively;
a second pressure plate disposed against the other end of said two elastic members, respectively; and
an adjusting member passing through said second pressure plate, a end of side adjusting member projective to a top of said second pressure plate.

2. The pressure adjusting structure for printing head of claim 1, wherein a holding member is disposed on the other end of said adjusting member.

3. The pressure adjusting structure for printing head of claim 1, wherein an outer thread is disposed on said adjusting member.

4. The pressure adjusting structure for printing head of claim 1, wherein said circuit board is a thermal printing head.

5. The pressure adjusting structure for printing head of claim 1, wherein said circuit board is against a wheel member.

6. The pressure adjusting structure for printing head of claim 1, wherein said circuit board is connected below said first pressure plate.

7. The pressure adjusting structure for printing head of claim 1, wherein a support member is disposed on said second pressure plate; and said adjusting member is projective to said support member.

8. The pressure adjusting structure for printing head of claim 1, wherein said adjusting member is located between said two elastic members.
